(19) United States
(12) Patent Application Publication
(10) Pub. No.: US 2022/0156789 A1
(43) Pub. Date: May 19, 2022

(54) INFORMATION PROCESSING APPARATUS, INFORMATION PROCESSING METHOD, AND PROGRAM

(71) Applicant: FELICA NETWORKS, INC., TOKYO (JP)

(72) Inventors: AKIE TSUNASHIMA, TOKYO (JP); JUN TADA, TOKYO (JP); MIKI KAKIZAWA, TOKYO (JP)

(21) Appl. No.: 17/439,470

(22) PCT Filed: Mar. 13, 2020
(86) PCT No.: PCT/JP2020/011030

§ 371 Date: Sep. 15, 2021

(30) Foreign Application Priority Data
Mar. 26, 2019 (JP) 2019-059514

(51) Int. Cl. G06Q 30/02

(52) U.S. Cl. CPC G06Q 30/0255; G06Q 30/0203

(57) ABSTRACT

To make it possible to effectively present information of a questionnaire, an advertisement, and so forth to a user terminal. Presentation information to be presented to a user is changed on the basis of attribute information and purchase information of the user. For example, this change includes a change of contents and/or a presentation timing of the presentation information. It becomes possible to present information having appropriate contents to a user terminal at an appropriate timing according to a situation of the user, and thus, information of a questionnaire, an advertisement, and so forth can effectively be presented to the user terminal.

### TECHNICAL FIELD

The present technology relates to an information processing apparatus, an information processing method, and a program, and particularly to an information processing apparatus and so forth for presentation of a questionnaire, an advertisement, and so forth to a user terminal.

### BACKGROUND ART

For example, PTL 1 discloses a questionnaire implementation system in which a questionnaire management server sends a questionnaire to user terminals to acquire answers of users of the user terminals. In a case where contents or the timing of the questionnaire does not take situations of the users into consideration, the response rate is low, and the credibility of the answers is also low. Even if a questionnaire asking how a user feels after using a product is displayed upon purchase of the product or at the time of receiving a delivery message, the product may not have been used as yet, or it may not be an appropriate timing for the user to answer the questionnaire.

### CITATION LIST

### Patent Literature

[PTL 1]

Japanese Patent Laid-Open No. 2013-210917

### SUMMARY

### Technical Problem

It is an object of the present technology to make it possible to effectively present information of a questionnaire, an advertisement, and so forth to user terminals.

### Solution to Problem

An aspect of the present technology resides in an information processing apparatus that generates information based on attribute information and purchase information of a user. The information processing apparatus includes an information processing unit that makes a change to presentation information to be presented to the user, on the basis of the attribute information and the purchase information.

In the present technology, the information processing unit makes a change to the presentation information to be presented to the user, on the basis of the attribute information and the purchase information of the user. For example, the presentation information may include a questionnaire. Further, for example, the presentation information may include an advertisement. In addition, for example, the presentation information may include presentation information to be presented in multiple steps. Further, for example, the change may be a change of contents of the presentation information and/or a change of a presentation timing of the presentation information. In such a case, it becomes possible to present information having appropriate contents to a user terminal at an appropriate timing according to a situation of the user.

For example, the purchase information may be acquired from image data of a receipt imaged by a terminal of the user. Further, in such a case, for example, the information processing unit may make a change to the presentation information further on the basis of information obtained by matching the purchase information with a master. In such a case, it becomes possible to change the presentation information for the user on the basis of the purchase information that is acquired from the image data of the receipt and is then normalized or on the basis of additional information.

Further, for example, the purchase information may be acquired from ID-POS information associated with the user. In such a case, it becomes possible to obtain purchase information of the relevant user even if the user does not image a receipt and transmit image data of the receipt.

In such a manner, in the present technology, the presentation information to be presented to the user is changed on the basis of the attribute information and the purchase information of the user. Therefore, it becomes possible to present information having appropriate contents to the user terminal at an appropriate timing according to a situation of the user, and information of a questionnaire, an advertisement, or the like can effectively be presented to the user terminal.

It is to be noted that, in the present technology, the information processing unit may make a change to the presentation information further on the basis of information of a terminal of the user, for example. In such a case, it becomes possible to present such information that contents thereof and a presentation timing are more suitable for the situation of the user, to the user terminal. Further, in the present technology, for example, the attribute information of the user may further include information regarding reception rejection of predetermined presentation information.

Further, in the present technology, for example, the presentation information is used to ask the user to give an answer, and the information processing apparatus may further include an incentive granting unit that gives an incentive to a user who has given the answer. By this, it becomes possible to increase the response rate of users.

Further, in the present technology, for example, the information processing apparatus may further include an information registration unit in which the presentation information having a presentation condition is registered, and the information processing unit may decide the presentation information having the presentation condition conforming to the attribute information and the purchase information of the user, as presentation information to be presented to a terminal of the user. By this, it becomes possible to present information having appropriate contents to the user terminal at an appropriate timing according to a situation of the user.

### BRIEF DESCRIPTION OF DRAWINGS

FIG. 1 is a block diagram depicting an example of a configuration of an information processing system.

FIG. 2 is a view depicting an example of information indicated on a receipt.

FIG. 3 is a view depicting an example of information to be added to a receipt according to a business category.

FIG. 4 depicts views of an example of terminal information and user attribute information.

FIG. 5 depicts views of a matching process with a master.

FIG. 6 is a view depicting an example of a processing sequence.

FIG. 7 is a view depicting an example of how to decide a questionnaire (example of display decision) by a business operator terminal.

FIG. 8 is a view depicting an example of how to decide a questionnaire (example of display decision) by the business operator terminal.

FIG. 9 is a fan page relating to a measure that utilizes the present technology.

FIG. 10 is a block diagram depicting an example of a hardware configuration of an office terminal.

### DESCRIPTION OF EMBODIMENT

In the following, a mode for carrying out the invention (hereinafter referred to as an “embodiment”) will be described. It is to be noted that the description is given in the following order.

1. Embodiment

2. Modification

### 1. Embodiment

### Example of Configuration of Information Processing System

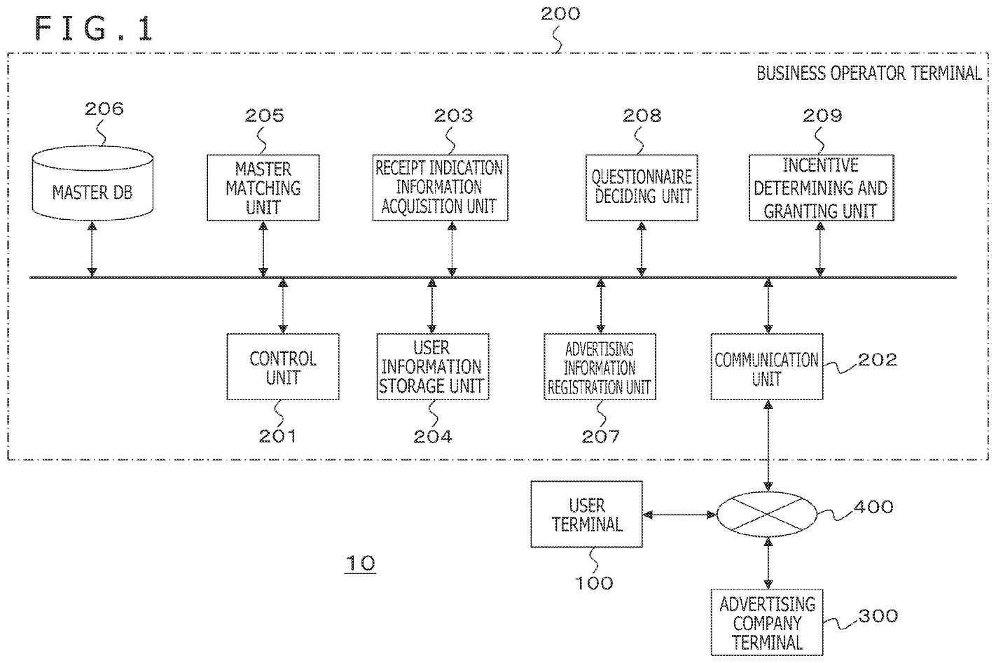

FIG. 1 depicts an example of a configuration of an information processing system 10. The information processing system 10 includes a user terminal 100, a business operator terminal 200, and an advertising company terminal 300. The business operator terminal 200 is connected to the user terminal 100 and the advertising company terminal 300 through a network 400 such as the Internet.

The user terminal 100 is, for example, a terminal such as a smartphone or a tablet. A user uses the user terminal 100 to send receipt image data obtained by imaging a receipt, to the business operator terminal 200 through the network 400. In addition, the user uses the user terminal 100 to receive a questionnaire decided according to purchase information included in the receipt image data, from the business operator terminal 200 through the network 400.

Further, the user uses the user terminal 100 to send an answer to a questionnaire to the business operator terminal 200 through the network 400. Further, the user uses the user terminal 100 to receive an incentive such as a point based on the answer to the questionnaire, from the business operator terminal 200 through the network 400.

An advertising company uses the advertising company terminal 300 to register advertising information to the business operator terminal 200 through the network 400. The advertising information includes, in addition to a questionnaire, information defining presentation conditions such as a product, an incentive, company information, and a questionnaire acquisition fee. Multiple advertising companies can coexist, and therefore, multiple advertising company terminals 300 can be provided.

The business operator terminal 200 selects a questionnaire having appropriate contents from among a predetermined number of registered questionnaires, on the basis of not only purchase information included in receipt image data sent from the user terminal 100 but also information of the user terminal 100, attribute information of the user, and so forth. Then, the business operator terminal 200 sends and presents the selected questionnaire to the user terminal 100 through the network 400 at an appropriate timing.

Further, the advertising company uses the advertising company terminal 300 to receive information regarding answers to the questionnaire and an incentive granting situation from the business operator terminal 200 through the network 400.

The business operator terminal 200 includes a control unit 201, a communication unit 202, a receipt indication information acquisition unit 203, a user information storage unit 204, a master matching unit 205, a master database (master DB) 206, an advertising information registration unit 207, a questionnaire deciding unit 208, and an incentive determining and granting unit 209.

The control unit 201 controls operation of each component of the business operator terminal 200. The communication unit 202 communicates with the user terminal 100 and the advertising company terminal 300 through the network 400. The receipt indication information acquisition unit 203 processes receipt image data acquired from the user terminal 100 through the communication unit 202, to acquire information indicated on a receipt.

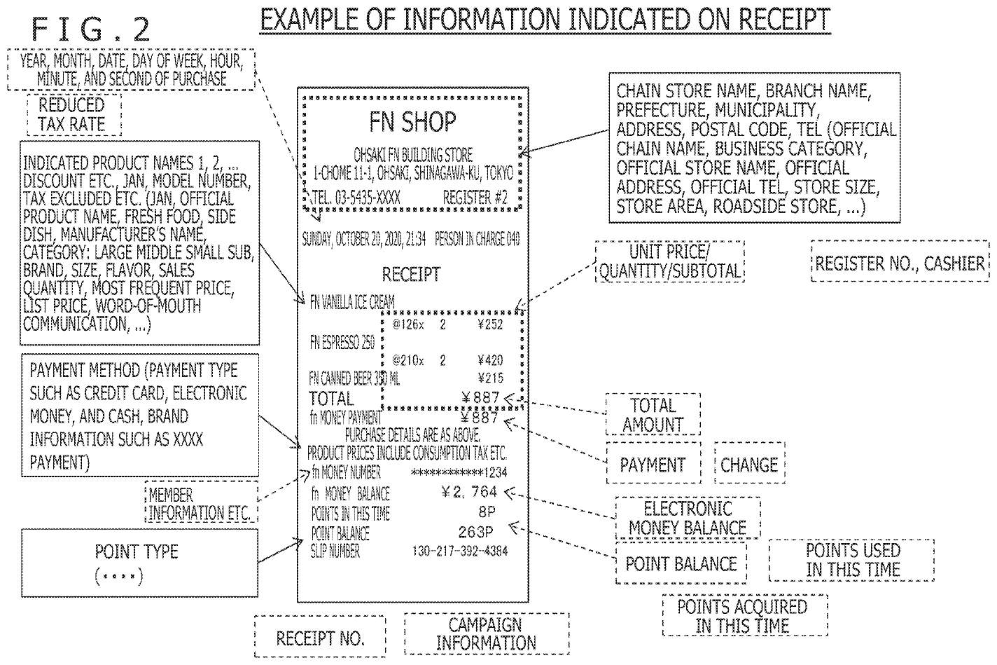

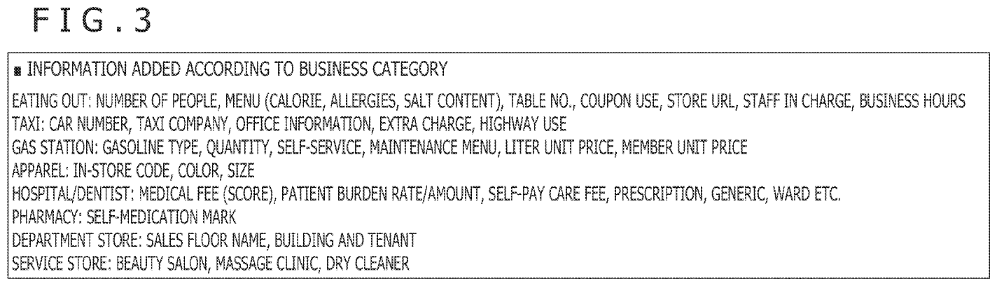

FIG. 2 depicts an example of information indicated on a receipt. The information indicated on the receipt includes time information such as the year, month, date, day of the week, hour, minute, and second of purchase, store information such as a chain store name, a branch name, an address, and a telephone number, purchased product information such as a product indication name, a price, a quantity, and a total amount of money, payment information such as a payment method, and other information. Further, the information indicated on the receipt may include information added to the receipt according to the business category, as illustrated in an example of FIG. 3.

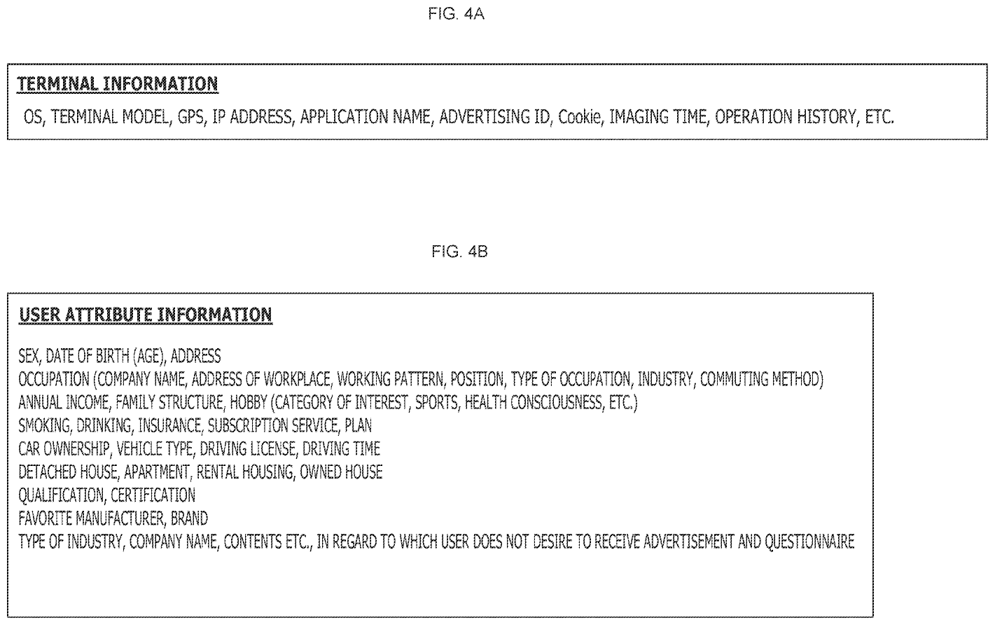

The user information storage unit 204 stores information indicated on a receipt that is acquired by the receipt indication information acquisition unit 203. Further, the user information storage unit 204 stores terminal information of the user terminal 100 from which receipt image data has been received, the terminal information being acquired through the communication unit 202. The terminal information includes, as illustrated in an example of FIG. 4(a), information regarding an OS, a terminal model, a GPS, an IP address, an application name, an advertisement ID, Cookie, imaging time, an operation history, and so forth.

Further, the user information storage unit 204 records registered user attribute information of a user who is an owner of the user terminal 100 from which receipt image data has been sent, the user attribute information being acquired through the communication unit 202. The user attribute information includes, as illustrated in an example of FIG. 4(b), information regarding sex, a date of birth, an address, an occupation, an annual income, a family structure, a hobby as well as a type of industry, a company name, and contents in regard to which the user does not desire to receive a questionnaire. The information regarding the type of industry, the company name, and the contents in regard to which the user does not desire to receive a questionnaire is included in information regarding reception rejection of the questionnaire.

The master matching unit 205 performs a process of matching information indicated on a receipt with a master retained in the master database (master DB) 206, to normalize the information indicated on the receipt or additionally acquire information that cannot be specified only from the information described on the receipt. Here, normalization signifies conversion into an official or general term. For example, information subjected to the process of matching with the master is, in the example of the information described on the receipt in FIG. 2, purchased product information, payment information, and so forth in which orthographical variants appear, for example, among different stores.

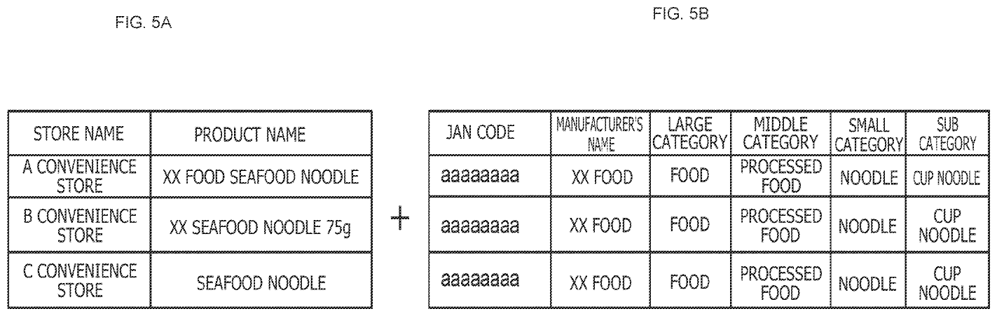

FIG. 5(a) depicts an example of store names and product names acquired as the information indicated on a receipt. Here, in regard to the same product, the product name is “XX Food seafood noodle” in a receipt of an “A convenience store,” the product name is “XX seafood noddle” in a receipt of a “B convenience store,” and the product name is “seafood noodle” in a receipt of a “C convenience store.”

In the master database 206, in association with the store names and the product names mentioned above, information regarding manufacturer's names and product classifications as well as information regarding JAN codes, which is additional information, is provided as a master, as depicted in FIG. 5(b). Therefore, by matching a store name and a product name that are acquired as the information indicated on the receipt, with the master, a manufacturer's name and a product classification are obtained as normalization information, and a JAN code and so forth are obtained as additional information, for example.

It is to be noted that the master relating to the product names in FIG. 5 is an example and is not restrictive. Also, it is conceivable that a master relating to other information indicated on a receipt is provided and that information indicated on the receipt is normalized or that information that cannot be specified only from the information described on the receipt is acquired additionally. The information acquired by the master matching unit 205 is also stored into the user information storage unit 204 in association with the information described on the receipt.

The advertising information registration unit 207 sets registered advertising information according to an advertising information registration from the advertising company terminal 300. As described hereinabove, the advertising information includes, in addition to a questionnaire, information defining presentation conditions such as a product, an incentive, company information, and a questionnaire acquisition fee. In such a case, the same advertising company may register multiple pieces of advertising information, or multiple advertising companies may individually register pieces of advertising information.

The questionnaire deciding unit 208 refers to the information indicated on the receipt, the terminal information, the user attribute information, and so forth that are stored in the user information storage unit 204, to decide a questionnaire that satisfies the presentation conditions, from among a predetermined number of questionnaires registered in the advertising information registration unit 207. Then, the questionnaire deciding unit 208 transmits and presents the questionnaire from the communication unit 202 to the user terminal 100.

The incentive determining and granting unit 209 decides an incentive on the basis of answers to the questionnaire that are sent from the user terminal 100, and sends the incentive to the user terminal 100 through the communication unit 202. It is to be noted that a point, electronic money, a real product, or the like is applicable as the incentive. Further, the incentive that a user can receive may be made selectable from among candidates by the business operator or the user. Further, the incentive determining and granting unit 209 sends information regarding the answers to the questionnaire and an incentive granting situation to the advertising company terminal 300 through the communication unit 202.

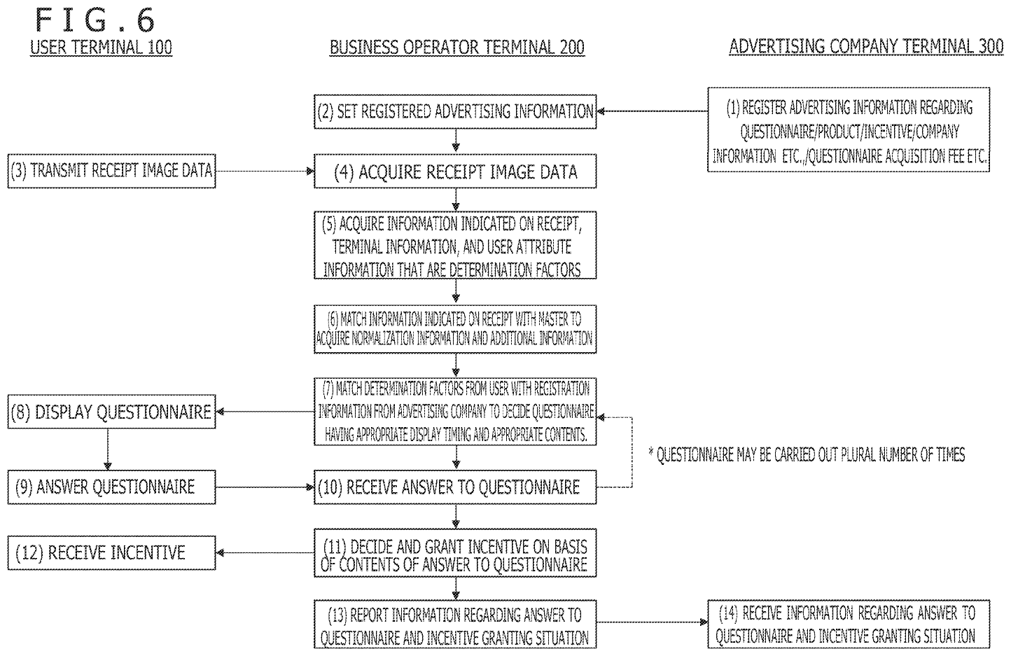

FIG. 6 depicts an example of a processing sequence of the information processing system 10 depicted in FIG. 1.

(1) The advertising company terminal 300 registers advertising information.

(2) The business operator terminal 200 sets the advertising information registered by the advertising company terminal 300, in the advertising information registration unit 207.

(3) The user terminal 100 images a receipt and transmits receipt image data to the business operator terminal 200.

(4) The business operator terminal 200 acquires the receipt image data sent from the user terminal 100.

(5) The business operator terminal 200 causes the receipt indication information acquisition unit 203 to process the receipt image data, to thereby acquire information indicated on the receipt and further acquire terminal information and user attribute information from the user terminal 100.

(6) The business operator terminal 200 causes the master matching unit 305 to match the acquired information with the master of the master database 206, to thereby acquire normalization information or additional information.

(7) The business operator terminal 200 causes the questionnaire deciding unit 208 to match determination information from the user (information described on the receipt, terminal information, and user attribute information) and registration information from the advertising company with each other to decide a questionnaire having an appropriate display timing and appropriate contents.

Here, an advertising company by which the highest advertisement delivery fee and questionnaire acquisition fee have been presented is selected on a real time basis according to the determination information. On the other hand, by matching the user attribute information with the business type, company names, contents, and so forth in regard to which the user does not desire to receive a questionnaire, it becomes possible to distribute a questionnaire that is optimum and valuable also for the user side.

(8) The user terminal 100 displays the questionnaire sent from the business operator terminal 200.

(9) The user terminal 100 sends answers to the questionnaire to the business operator terminal 200.

(10) The business operator terminal 200 receives the answers to the questionnaire sent from the user terminal 100.

It is to be noted that transmission of a questionnaire from the business operator terminal 200 to the user terminal 100 and transmission of answers to the questionnaire from the user terminal 100 to the business operator terminal 200 are sometimes repeated in two or more steps.

(11) The business operator terminal 200 causes the incentive determining and granting unit 209 to decide an incentive on the basis of contents of the answers to the questionnaire and give the incentive to the user terminal 100.

(12) The user terminal 100 receives the incentive sent from the business operator terminal 200.

(13) The business operator terminal 200 causes the incentive determining and granting unit 209 to report information regarding the answers to the questionnaire and incentive granting situation to the advertising company terminal 300.

(14) The advertising company terminal 300 receives the information regarding the answers to the questionnaire and the incentive granting situation.

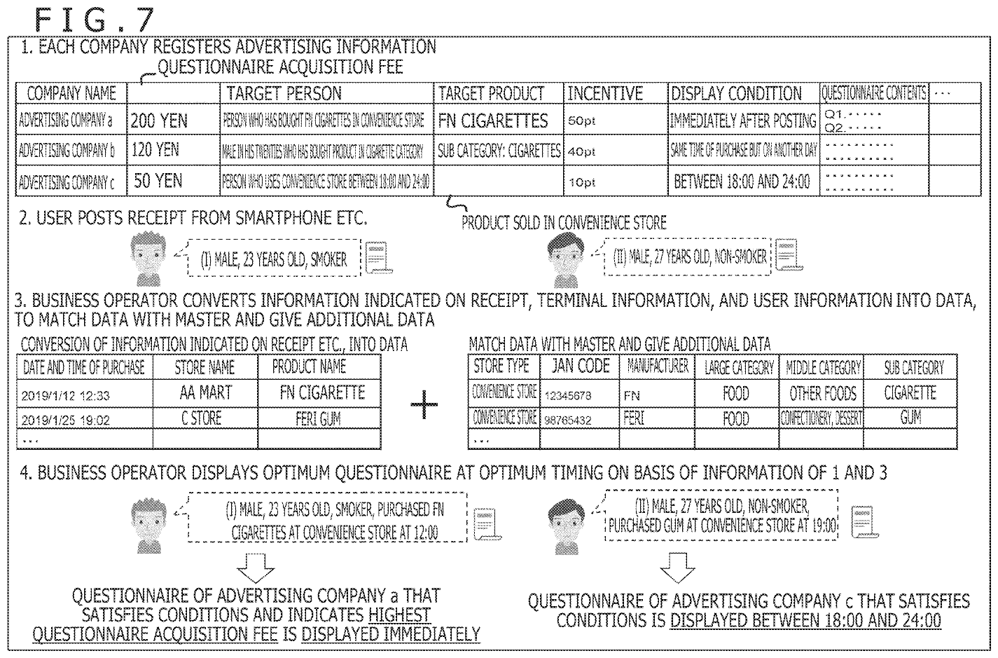

FIG. 7 depicts an example of how to decide a questionnaire (example of display decision) by the business operator terminal 200. In this example, a case where a questionnaire is sent out only in one step, that is, only a main questionnaire is sent out, is illustrated.

“1. Each Company Registers Advertising Information”

Here, conditions relating to advertising information of an advertising company a are as follows. The questionnaire acquisition fee is “200 yen,” the target person is a “person who has bought the FN cigarettes in a convenience store,” the target product is “FN cigarettes,” the incentive is “50 pt,” the display condition is to display the questionnaire “immediately after posting,” and so forth.

Conditions relating to advertising information of an advertising company b are as follows. The questionnaire acquisition fee is “120 yen,” the target person is a “male in his twenties who has bought a product in the cigarette category,” the target product is “sub category: cigarettes,” the incentive is “40 pt,” the display condition is to display the questionnaire “at the same time of purchase but on another day,” and so forth. Further, conditions relating to advertising information of an advertising company c are as follows. The questionnaire acquisition fee is “50 yen,” the target person is “a person who uses a convenience store between 18:00 and 24:00,” the target product is a “product sold in a convenience store,” the incentive is “10 pt,” the display condition is to display the questionnaire “between 18:00 and 24:00,” and so forth.

“2. User Posts Receipt from Smartphone or the Like”

Here, a user (I) is a male, 23 years old, and a smoker. A user (II) is a male, 27 years old, and a non-smoker.

“3. Business Operator Converts Information Indicated on Receipt, Terminal Information, and User Information into Data, to Match Data with Master and Give Additional Data”

Here, information indicated on a receipt of the user (I) includes the date and time of purchase “2019/1/12 12:33,” the store name “AA mart,” and the product name “FN cigarettes.” When the information indicated on the receipt is matched with the master, information regarding the store type “convenience store,” the JAN code “12345678,” the manufacturer “FN,” the large category “food,” the middle category “other foods,” and the sub category “cigarette” is added.

Information indicated on a receipt of the user (II) includes the date and time of purchase “2019/1/25 19:02,” the store name “C store,” and the product name “Feri gum.” When the information indicated on the receipt is matched with the master, information regarding the store type “convenience store,” the JAN code “98765432,” the manufacturer “Feri,” the large category “food,” the middle category “confectionery and dessert,” and the sub category “gum” is added.

“4. Business Operator Displays Optimum Questionnaire at Optimum Timing on Basis of Information of 1 and 3”

Here, the user (I) is a male, 23 years old, and a smoker, and it is found, from the information indicated on the receipt and so forth, that the user purchased FN cigarettes at a convenience store at 12:00. Accordingly, a questionnaire of the advertising company a that satisfies the conditions and indicates the highest questionnaire acquisition fee is selected and displayed immediately.

The user (II) is a male, 23 years old, and a non-smoker, and it is found, from the information indicated on the receipt and so forth, that the user purchased a gum at a convenience store at 19:00. Accordingly, a questionnaire of the advertising company c that satisfies the conditions is displayed between 18:00 and 24:00.

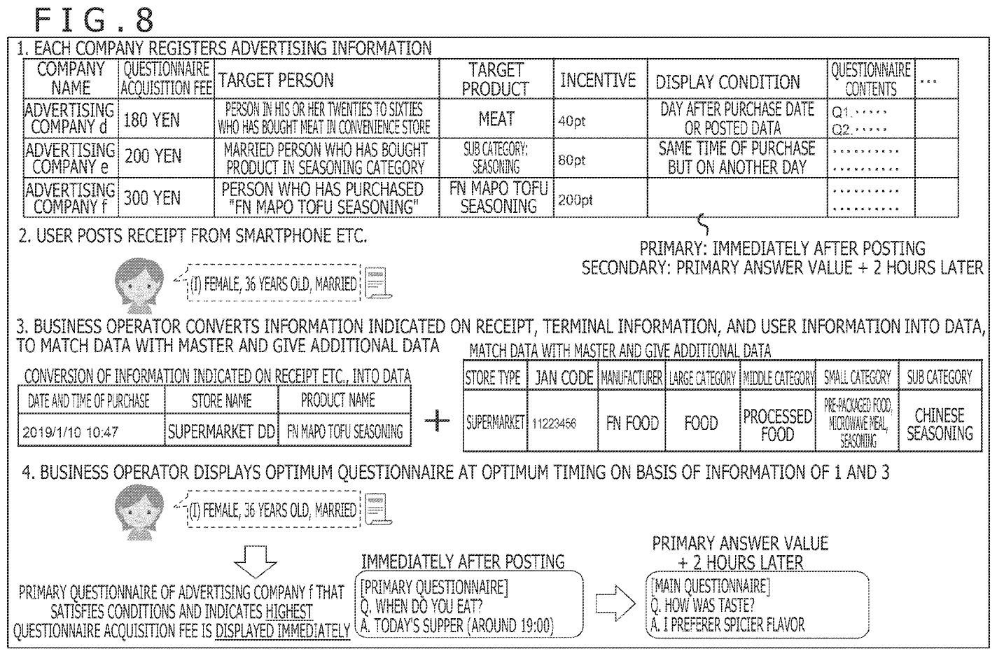

FIG. 8 depicts an example of how to decide a questionnaire (example of display decision) by the business operator terminal 200. In this example, a case where a questionnaire is performed in two steps, that is, a primary questionnaire and a main questionnaire are sent out, is illustrated.

“1. Each Company Registers Advertising Information”

Here, conditions relating to advertising information of an advertising company d are as follows. The questionnaire acquisition fee is “180 yen,” the target person is “a person in his or her twenties to sixties who has bought meat in a supermarket,” the target product is “meat,” the incentive is “40 pt,” the display condition is to display the questionnaire “on the day after the purchase date or on the posted data,” and so forth.

Conditions relating to advertising information of an advertising company e are as follows. The questionnaire acquisition fee is “200 yen,” the target person is “a married person who has bought a product in the seasoning category,” the target product is “sub category: seasoning,” the incentive is “80 pt,” the display condition is to display the questionnaire “at the same time of purchase but on another day,” and so forth. Further, conditions relating to advertising information of an advertising company f are as follows. The questionnaire acquisition fee is “300 yen,” the target person is “a person who has purchased an FN mapo tofu seasoning,” the target product is “FN mapo tofu seasoning,” the incentive is “200 pt,” the display condition is to display the questionnaire “primary: immediately after posting, secondary: primary answer value+2 hours later,” and so forth.

“2. User Posts Receipt from Smartphone or the Like”

Here, a user (I) is a female, is 36 years old, and is married.

“3. Business Operator Converts Information Indicated on Receipt, Terminal Information, User Information into Data, to Match Data with Master and Give Additional Data”

Here, information indicated on a receipt of the user (I) includes the date and time of purchase “2019/1/10 10:47,” the store name “supermarket DD,” and the product name “FN mapo tofu seasoning.” When the information indicated on the receipt is matched with information of the master, information regarding the store type “supermarket,” the JAN code “11223456,” the manufacturer “FN food,” the large category “food,” the middle category “processed food,” the small category “pre-packaged food, microwave meal, seasoning,” and the sub category “Chinese seasoning” is added.

“4. Business Operator Displays Optimum Questionnaire at Optimum Timing on Basis of Information of 1 and 3”

Here, the user (I) is a female, is 36 years old, and is married, and it is found, from the information indicated on the receipt and so forth, that the user purchased the FN mapo tofu seasoning. Accordingly, a questionnaire of the advertising company f that satisfies the conditions and indicates the highest questionnaire acquisition fee is selected, and the primary questionnaire is displayed immediately. Then, after the primary answer value+2 hours later, the main questionnaire is displayed.

As described hereinabove, in the information processing system 10 depicted in FIG. 1, the business operator terminal 200 changes contents and a presentation timing of a questionnaire to be sent to the user terminal 100, according to acquisition information relating to the user and including purchase information of the user. Therefore, it becomes possible to present a questionnaire having appropriate contents to a user terminal at an appropriate timing according to a situation of the user, and presentation of the questionnaire to the user terminal 100 can be performed effectively.

It is to be noted that the advantageous effects described in the present specification are exemplary and are not restrictive. Further, additional advantageous effects may be obtained.

“Measure that Takes Advantage of Present Technology”

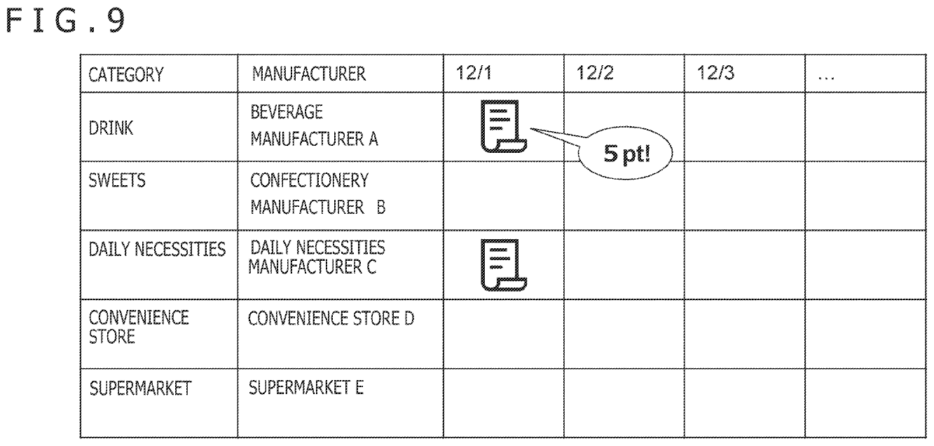

A measure that takes advantage of the present technology will be described. This measure is an example of a service for creating an opportunity for a user to upload (transmit) receipt image data. In this measure, a user can access a neutral fan page depicted in FIG. 9. In this fan page, one manufacturer is registered for each category. The companies registered in the fan page are, for example, companies that sponsor a life support campaign.

A user can upload receipt image data regarding purchase of a product of a relevant manufacturer once every day. If it can be confirmed, through an examination of the receipt image data, that the product of the relevant manufacturer has been purchased as claimed by the user, points set for one receipt upload, specifically five points in the example in FIG. 9, are returned to the user.

An advertising company can present a user who satisfies the conditions, with a questionnaire having appropriate contents, an advertisement, a coupon, sale information, and so forth at an optimum timing, on the basis of information of the uploaded receipt and registered user information. Also, companies other than the advertising company can approach users of the present fan site as an advertisement menu.

“Example of Hardware Configuration of Business Operator Terminal”

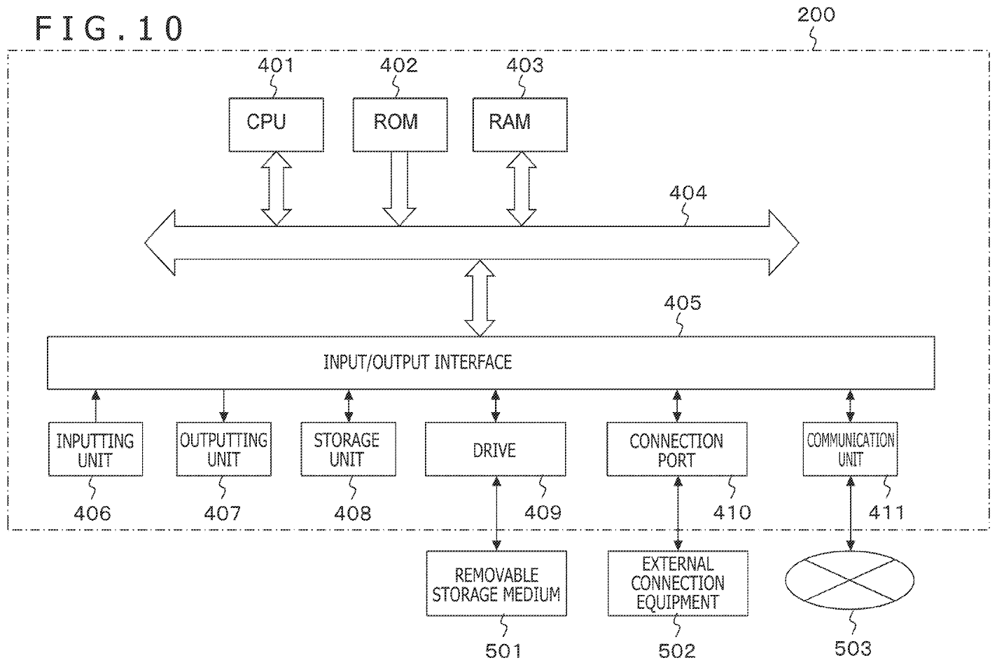

An example of a hardware configuration of the business operator terminal 200 as an information processing apparatus will be described. FIG. 10 depicts an example of the hardware configuration of the business operator terminal 200.

The business operator terminal 200 includes a CPU 401, a ROM 402, a RAM 403, a bus 404, an input/output interface 405, an inputting unit 406, an outputting unit 407, a storage unit 408, a drive 409, a connection port 410, and a communication unit 411. It is to be noted that the hardware configuration described here is an example, and some of the components may be omitted. Further, the business operator terminal 200 may further include a component or components other than the components described here.

The CPU 401 functions as, for example, an arithmetic processing unit or a control device and controls whole or part of operation of the respective components on the basis of various programs recorded in the ROM 402, the RAM 403, or the storage unit 408 or in a removable storage medium 501.

The ROM 402 is means that stores programs to be read into the CPU 401, data to be used in arithmetic operation, and so forth. In the RAM 403, for example, programs to be read into the CPU 401, various parameters that vary suitably when the programs are executed, and so forth are stored temporarily or permanently.

The CPU 401, the ROM 402, and the RAM 403 are connected to each other through the bus 404. Meanwhile, various components are connected to the bus 874 through the input/output interface 405.

As the inputting unit 406, for example, a mouse, a keyboard, a touch panel, buttons, switches, levers, and so forth are used. Further, as the inputting unit 878, a remote controller (hereinafter referred to as a remote) capable of transmitting a control signal by using infrared rays or some other radio waves is sometimes used.

For example, the outputting unit 407 is a display device such as a CRT (Cathode Ray Tube), an LCD, or an organic EL device, an audio outputting device such as a speaker or headphones, or a device that can visually or audibly notify a user of acquired information, such as a printer, a mobile phone, or a facsimile.

The storage unit 408 is a device that stores various types of data. As the storage unit 408, for example, a magnetic storage device such as a hard disk drive (HDD), a semiconductor storage device, an optical storage device, a magneto-optical storage device, or the like is used.

The drive 409 is, for example, a device that reads out information recorded in the removable storage medium 501 such as a magnetic disk, an optical disk, a magneto-optical disk, or a semiconductor memory, or that writes information into the removable storage medium 501.

The removable storage medium 501 includes, for example, a DVD medium, a Blu-ray (registered trademark) medium, an HD DVD medium, various types of semiconductor storage media, and so forth. Needless to say, the removable storage medium 501 may be, for example, an IC card in which a contactless IC chip is incorporated, an electronic equipment, or the like.

The connection port 410 is, for example, a USB (Universal Serial Bus) port, an IEEE 1394 port, an SCSI (Small Computer System Interface), an RS-232C port, or a port for connection of external connection equipment 502 such as an optical audio terminal. The external connection equipment 502 is, for example, a printer, a portable music player, a digital camera, a digital video camera, or an IC recorder.

The communication unit 411 is a communication device for connecting to a network 503 and is, for example, a communication card for a wired or wireless LAN, Bluetooth (registered trademark), or WUSB (Wireless USB), a router for optical communication, a router for the ADSL (Asymmetric Digital Subscriber Line), or a modem for various kinds of communication.

### 2. Modification

Incidentally, the embodiment described above has illustrated an example in which the business operator terminal 200 acquires purchase information of a user from receipt image data obtained by imaging a receipt by the user terminal 100. However, it is also conceivable to acquire purchase information of a user from an electronic receipt, mail information (an EC order, a delivery mail, or the like), a delivery note, ID-POS information, settlement information (mobile payment), or the like.

In a case where ID-POS information is used, a user to which a questionnaire is to be presented can be specified without transmission and reception of personal information, by combining information acquired from receipt image data and an ADID (Advertising ID) of a terminal upon receipt image transmission and then linking the combination with the ID-POS information. After the information is linked once, every time the user purchases a product by presenting a member card in the relevant store, it is possible to display an appropriate questionnaire on the terminal of the user on the basis of the ID-POS information.

Further, the embodiment described above illustrates an example in which the business operator terminal 200 transmits a questionnaire to the user terminal 100 and displays the questionnaire on the user terminal 100. However, the information to be presented on the user terminal 10 is not limited to a questionnaire and may possibly be an advertisement (sampling, affiliate, or the like), a coupon, sales information, or the like.

Further, while the preferred embodiment of the present disclosure has been described in detail with reference to the accompanying drawings, the technical scope of the present disclosure is not limited to such an example as described above. It is apparent that persons who have common knowledge in the technical field to which the present disclosure pertains can conceive various alterations or modifications within the scope of the technical idea described in the claims, and it is construed that such alterations and modifications naturally belong to the technical scope of the present disclosure.

Further, the advantageous effects described in the present specification are explanatory or exemplary and are not restrictive. In other words, the technology according to the present disclosure can exhibit, together with the advantageous effects described hereinabove or in place of the advantageous effects described hereinabove, other advantageous effects apparent to those skilled in the art from the description of the present specification.

It is to be noted that the present technology can also have such configurations as described below.

(1)

An information processing apparatus that generates information based on attribute information and purchase information of a user, the information processing apparatus including:

an information processing unit that makes a change to presentation information to be presented to the user, on the basis of the attribute information and the purchase information.

(2)

The information processing apparatus according to (1) above, in which

the information processing unit makes a change to the presentation information further on the basis of information of a terminal of the user.

(3)

The information processing apparatus according to (1) or (2) above, in which

the attribute information of the user includes information regarding reception rejection of predetermined presentation information.

(4)

The information processing apparatus according to any one of (1) to (3) above, in which

the change includes a change of contents of the presentation information.

(5)

The information processing apparatus according to any one of (1) to (3) above, in which

the change includes a change of a presentation timing of the presentation information.

(6)

The information processing apparatus according to any one of (1) to (5) above, in which

the presentation information includes presentation information to be presented in multiple steps.

(7)

The information processing apparatus according to any one of (1) to (6) above, in which

the presentation information is used to ask the user to give an answer, and

the information processing apparatus further includes an incentive granting unit that gives an incentive to a user who has given the answer.

(8)

The information processing apparatus according to any one of (1) to (7) above, in which

the purchase information is acquired from image data of a receipt imaged by the terminal of the user.

(9)

The information processing apparatus according to (8) above, in which

the information processing unit makes a change to the presentation information further on the basis of information obtained by matching the purchase information with a master.

(10)

The information processing apparatus according to any one of (1) to (7) above, in which

the purchase information is acquired from ID-POS information associated with the user.

(11)

The information processing apparatus according to any one of (1) to (10) above, in which

the presentation information includes a questionnaire.

(12)

The information processing apparatus according to any one of (1) to (11) above, in which the presentation information includes an advertisement.

(13)

The information processing apparatus according to any one of (1) to (12) above, further including:

an information registration unit in which the presentation information having a presentation condition is registered, in which

the information processing unit decides the presentation information having the presentation condition conforming to the attribute information and the purchase information, as presentation information for the terminal of the user.

(14)

An information processing method for generating information based on attribute information and purchase information of a user, the information processing method including:

an information processing procedure of making a change to presentation information to be presented to the user, on the basis of the attribute information and the purchase information.

(15)

A program causing a computer to function as:

information processing means that makes a change to presentation information to be presented to a user, on the basis of attribute information and purchase information of the user.

### REFERENCE SIGNS LIST

10: Information processing system
100: User terminal
200: Business operator terminal
201: Control unit
202: Communication unit
203: Receipt indication information acquisition unit
204: User information storage unit
205: Master matching unit
206: Master database
207: Advertising information registration unit
208: Questionnaire deciding unit
209: Incentive determining and granting unit
300: Advertising company terminal
400: Network

1. An information processing apparatus that generates information based on attribute information and purchase information of a user, the information processing apparatus comprising:
an information processing unit that makes a change to presentation information to be presented to the user, on a basis of the attribute information and the purchase information.

2. The information processing apparatus according to claim 1, wherein
the information processing unit makes a change to the presentation information further on a basis of information of a terminal of the user.

3. The information processing apparatus according to claim 1, wherein
the attribute information of the user includes information regarding reception rejection of predetermined presentation information.

4. The information processing apparatus according to claim 1, wherein
the change includes a change of contents of the presentation information.

5. The information processing apparatus according to claim 1, wherein
the change includes a change of a presentation timing of the presentation information.

6. The information processing apparatus according to claim 1, wherein
the presentation information includes presentation information to be presented in multiple steps.

7. The information processing apparatus according to claim 1, wherein
the presentation information is used to ask the user to give an answer, and
the information processing apparatus further includes an incentive granting unit that gives an incentive to a user who has given the answer.

8. The information processing apparatus according to claim 1, wherein
the purchase information is acquired from image data of a receipt imaged by a terminal of the user.

9. The information processing apparatus according to claim 8, wherein
the information processing unit makes a change to the presentation information further on a basis of information obtained by matching the purchase information with a master.

10. The information processing apparatus according to claim 1, wherein
the purchase information is acquired from ID-POS information associated with the user.

11. The information processing apparatus according to claim 1, wherein
the presentation information includes a questionnaire.

12. The information processing apparatus according to claim 1, wherein
the presentation information includes an advertisement.

13. The information processing apparatus according to claim 1, further comprising:
an information registration unit in which the presentation information having a presentation condition is registered, wherein
the information processing unit decides the presentation information having the presentation condition conforming to the attribute information and the purchase information, as presentation information for a terminal of the user.

14. An information processing method for generating information based on attribute information and purchase information of a user, the information processing method comprising:
an information processing procedure of making a change to presentation information to be presented to the user, on a basis of the attribute information and the purchase information.

15. A program causing a computer to function as:
information processing means that makes a change to presentation information to be presented to a user, on a basis of attribute information and purchase information of the user.
